(19) United States
(12) Patent Application Publication
(10) Pub. No.: US 2007/0216806 A1
(43) Pub. Date: Sep. 20, 2007

(54) Receiver apparatus and receiver system

(75) Inventor: Atsushi Maehara, Osaka (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka-shi (JP)

(21) Appl. No.: 11/607,011

(22) Filed: Dec. 1, 2006

(30) Foreign Application Priority Data
Mar. 17, 2006 (JP) 2006-073656

(51) Int. Cl. H04N 5/45

(52) U.S. Cl. 348/565

(57) ABSTRACT

In a receiver apparatus that converts a radio-frequency signal received by an antenna into video and audio signals, there are arranged on a single circuit board a tuner circuit portion that converts the radio-frequency signal received by the antenna into an intermediate-frequency signal, a digital demodulating portion that converts the intermediate-frequency signal outputted from the tuner circuit portion into a compressed digital signal, a digital circuit portion that converts the compressed digital signal outputted from the digital demodulating portion into digital video and audio signals, and a video/audio output circuit that converts the digital video and audio signals outputted from the digital circuit portion into analog video and audio signals. This makes it possible to realize a receiver system provided with a video display apparatus having a simple configuration.

This nonprovisional application claims priority under 35 U.S.C. § 119(a) on Patent Application No. 2006-073656 filed in Japan on Mar. 17, 2006, the entire contents of which are hereby incorporated by reference.

### BACKGROUND OF THE INVENTION

1. Field of the Invention

The present invention relates to a receiver apparatus and a receiver system for receiving a radio-frequency signal such as a digital television broadcast signal.

2. Description of Related Art

FIG. 5 is a block diagram showing an outline of the configuration of a conventional receiver system. The receiver system 900 shown in FIG. 5 is composed of: an antenna 901 for receiving a radio-frequency signal; a receiver apparatus 902 for performing predetermined processing on the signal received by the antenna 901 to obtain a desired signal; and a video display apparatus 903 for performing predetermined processing on the signal obtained by the receiver apparatus 902 to extract video and audio signals.

The receiver apparatus 902 is provided with: a tuner circuit portion 911 that converts the radio-frequency signal received by the antenna 901 into an intermediate-frequency signal; a digital demodulating portion 912 that converts the intermediate-frequency signal outputted from the tuner circuit portion 911 into a compressed digital signal; and a power supply portion 913 that feeds the tuner circuit portion 911 and the digital demodulating portion 912 with electric power from which they operate. The digital demodulating portion 912 is provided with a digital demodulating IC 914, which is a processing IC for converting the intermediate-frequency signal into a digital signal.

The video display apparatus 903 is provided with: a digital circuit portion 921 that converts the compressed digital signal fed from the receiver apparatus 902 into digital video and audio signals; a video/audio output circuit 922 that converts the digital video and audio signals outputted from the digital circuit portion 921 into analog video and audio signals; a display processing portion 923 that performs processing for displaying video based on the analog video signal outputted from the video/audio output circuit 922; an audio processing portion 924 that performs processing for outputting audio based on the analog audio signal outputted from the video/audio output circuit 922; and a power supply portion 925 that feeds the digital circuit portion 921, the video/audio output circuit 922, the display processing portion 923, and the audio processing portion 924 with electric power from which they operate. The digital circuit portion 921 is provided with: a video/audio processing IC 928 for extracting video and audio signals from the compressed digital signal; a video/audio processing memory 926 for temporarily storing data being processed during video/audio processing; and a program memory 927 for storing control codes for controlling the receiver apparatus.

In this conventional receiver system 900 configured as described above, the receiver apparatus 902 is electromagnetically shielded by being covered with a shield. On the other hand, the video display apparatus 903 has different functional sections mounted on the circuit board thereof, namely the video/audio processing IC 928, the video/audio processing memory 926, the program memory 927, the video/audio output circuit 922, the display processing portion 923, and the audio processing portion 924. This requires an accordingly large number of components and conductors to be mounted and laid on the circuit board of the video display apparatus 903, which thus necessitates the use of a multiple-layer circuit board.

Moreover, the above-mentioned functional sections mounted on the circuit board of the video display apparatus 903, namely the video/audio processing IC 928, the video/audio processing memory 926, the program memory 927, the video/audio output circuit 922, the display processing portion 923, and the audio processing portion 924 generate unnecessary electromagnetic emission and noise, against which measures need to be taken on the video display apparatus 903 as by providing it with an additional shield.

Furthermore, the above-mentioned functional sections mounted on the circuit board of the video display apparatus 903, namely the video/audio processing IC 928, the video/audio processing memory 926, the program memory 927, the video/audio output circuit 922, the display processing portion 923, and the audio processing portion 924 also generate heat, against which measures need to be taken as by increasing the area of the circuit board or providing it with an additional heat-dissipating plate.

### SUMMARY OF THE INVENTION

In view of the conventionally encountered inconveniences described above, it is an object of the present invention to provide a receiver system provided with a video display apparatus having a simple configuration.

To achieve the above object, according to one aspect of the present invention, a receiver apparatus that converts a radio-frequency signal received by an antenna into video and audio signals is provided with: a tuner circuit portion that converts the radio-frequency signal received by the antenna into an intermediate-frequency signal; a digital demodulating portion that converts the intermediate-frequency signal outputted from the tuner circuit portion into a compressed digital signal; an intermediate-frequency processing circuit portion that converts the intermediate-frequency signal outputted from the tuner circuit portion into an audio intermediate-frequency signal; a digital circuit portion that converts the compressed digital signal outputted from the digital demodulating portion into digital video and audio signals; and a video/audio output circuit that converts the digital video and audio signals outputted from the digital circuit portion into analog video and audio signals. Here, the tuner circuit portion, the digital demodulating portion, the intermediate-frequency processing circuit portion, the digital circuit portion, and the video/audio output circuit are arranged on a single circuit board, and the top and bottom faces of the single circuit board are entirely covered with a chassis.

When the digital circuit portion and the video/audio output circuit are mounted on the circuit board of the receiver apparatus as described above, a video display apparatus for displaying video based on a video signal outputted from the receiver apparatus and/or outputting audio based on an audio signal outputted from the receiver apparatus needs to be provided only with a display processing portion that displays video based on the video signal fed from the receiver apparatus and an audio processing portion that outputs audio based on the audio signal fed from the receiver apparatus, and thus does not need to be built on a multiple-layer circuit board. Furthermore, measures against heat generated by the digital circuit portion and the video/audio output circuit can be taken in the receiver apparatus, and hence, in the video display apparatus, no measures need to be taken against heat as by increasing the area of the circuit board thereof or providing therewith an additional heat-dissipating plate. Moreover, no output terminal for a signal from the tuner circuit portion needs to be arranged outside the chassis, and this prevents noise from outside the receiver apparatus from entering the tuner circuit portion, and thus helps prevent degradation of the performance of the tuner circuit portion. The present invention is particularly effective in a case where received video is displayed by use of a video display apparatus provided with a circuit that demodulates an inputted audio intermediate-frequency signal. The single circuit board may be enclosed in the chassis, and this makes it possible to prevent the entry of noise from outside into the components on the circuit board more effectively.

According to the present invention, in the receiver apparatus, the intermediate-frequency processing circuit portion may include an intermediate-frequency processing IC for converting the intermediate-frequency signal into the audio intermediate-frequency signal; the digital circuit portion may include a video/audio processing IC that demodulates compressed digital video and audio signals and a video/audio processing memory that stores the compressed digital video and audio signals and the demodulated digital video and audio signals; and the digital demodulating portion may include a digital demodulating IC, which is a processing IC for converting the intermediate-frequency signal into a digital signal. Here, the intermediate-frequency processing IC, the video/audio processing IC, and the digital demodulating IC may be arranged in positions apart from one another on a same mount face.

With this configuration, it is possible to prevent the digital noise generated by the video/audio processing memory from entering the tuner circuit portion and the intermediate-frequency processing circuit portion, and thereby to prevent degradation of performance. It is also possible to disperse the heat generated by the digital demodulating IC provided in the digital demodulating portion and the heat generated by the video/audio processing IC provided in the digital circuit portion to spread out, and thereby to prevent degradation of performance more effectively.

According to the present invention, in the receiver apparatus, the intermediate-frequency processing circuit portion may be electromagnetically shielded from the video/audio processing IC and the digital demodulating IC.

With this configuration, it is possible to prevent the digital noise generated by the video/audio processing memory from entering the intermediate-frequency processing circuit portion, and thereby to prevent degradation of performance.

According to the present invention, in the receiver apparatus, the video/audio processing IC and the digital demodulating IC may be arranged in positions apart from each other on the same mount face, and the intermediate-frequency processing IC may be arranged on the face opposite from the mount face where the video/audio processing IC and the digital demodulating IC are arranged.

With this configuration, it is possible to prevent the digital noise generated by the video/audio processing memory from entering the intermediate-frequency processing circuit portion, and thereby to prevent degradation of performance.

According to another aspect of the present invention, a receiver system that receives digital and analog broadcast signals, converts them into video and audio signals, and displays video and/or outputs audio according thereto is provided with: the above described receiver apparatus; and a video display apparatus that displays video based on a video signal outputted from the receiver apparatus and/or outputs audio based on an audio signal outputted from the receiver apparatus.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing an outline of the configuration of a receiver system according to the present invention;

FIG. 2A is a diagram schematically showing how different functional sections are mounted on the receiver apparatus 3 shown in FIG. 1 (as seen from the top face thereof);

FIG. 2B is a diagram schematically showing how different functional sections are mounted on the receiver apparatus 3 shown in FIG. 1 (as seen from the bottom face thereof);

FIG. 3 is a diagram schematically showing another example of how different functional sections are mounted on the receiver apparatus 3 shown in FIG. 1;

FIG. 4 is a diagram schematically showing still another example of how different functional sections are mounted on the receiver apparatus 3 shown in FIG. 1; and

FIG. 5 is a block diagram showing an outline of the configuration of a conventional receiver system.

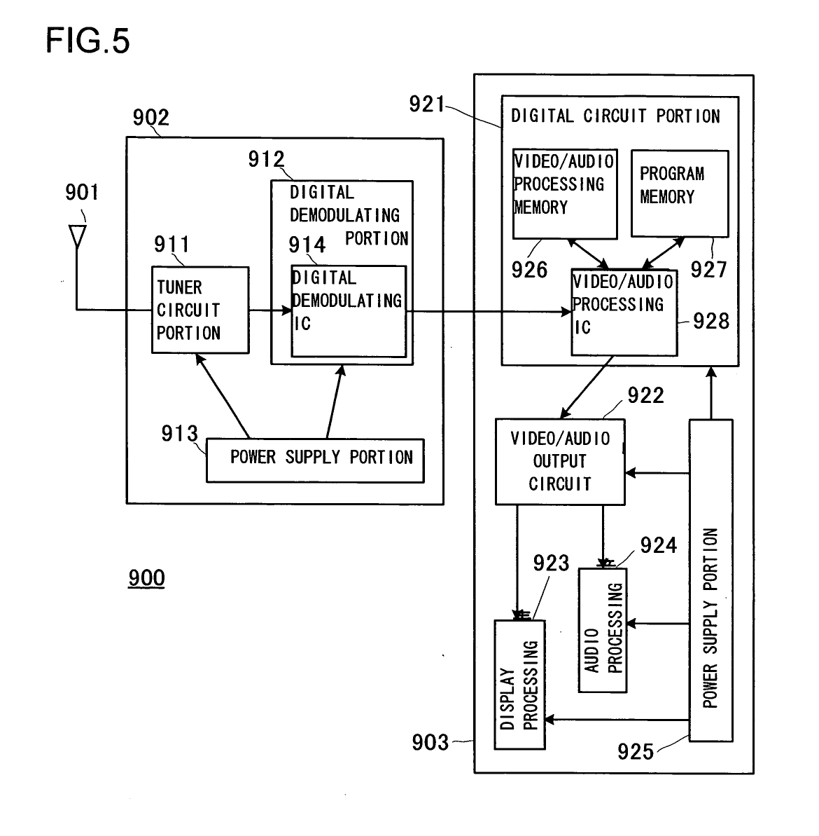

### DETAILED DESCRIPTION OF PREFERRED EMBODIMENTS

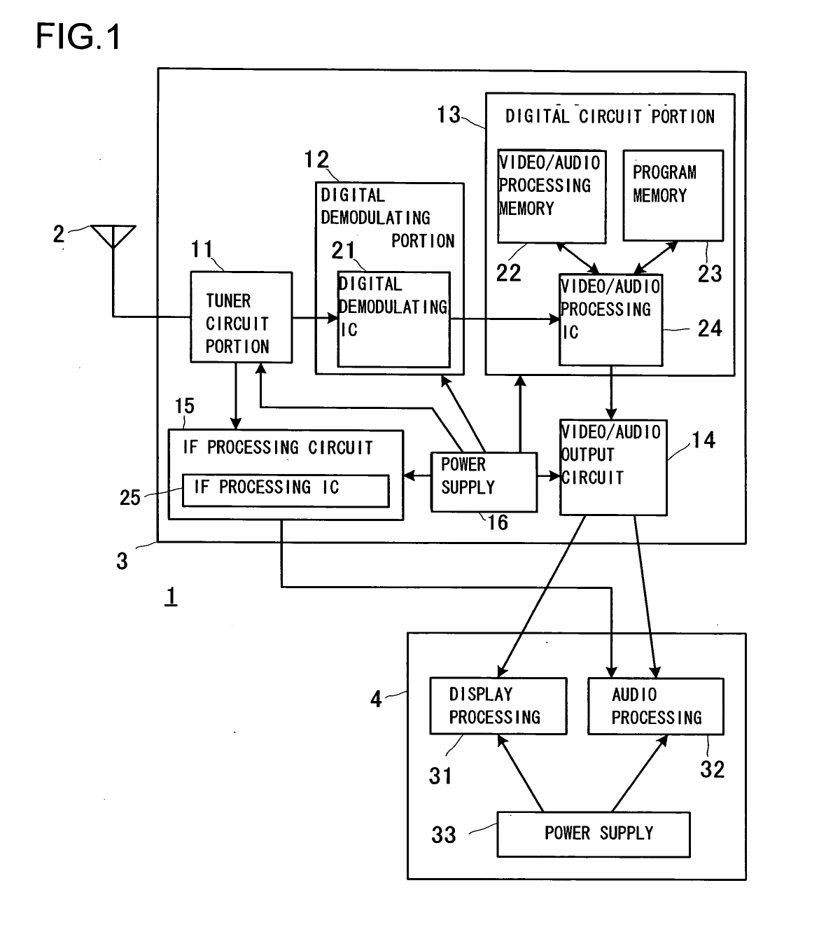

Hereinafter, the configuration of a receiver system according to the present invention will be described with reference to the accompanying drawings. FIG. 1 is a block diagram showing an outline of the configuration of the receiver system according to the present invention.

The receiver system 1 shown in FIG. 1 is composed of: an antenna 2 for receiving a radio-frequency signal; a receiver apparatus 3 for performing predetermined processing on the signal received by the antenna 2 to acquire video and audio signals; and a video display apparatus 4 for displaying video based on the video signal fed from the receiver apparatus 3 and/or outputs audio based on the audio signal fed from the receiver apparatus 3. The antenna 2 is connected via a coaxial cable to a tuner input terminal of the receiver apparatus 3, and an interface terminal of the receiver apparatus 3 is connected to the video display apparatus 4.

The receiver apparatus 3 is provided with: a tuner circuit portion 11 that converts the radio-frequency signal received by the antenna 2 into an intermediate-frequency signal (hereinafter referred to as “IF signal”); a digital demodulating portion 12 that converts the IF signal outputted from the tuner circuit portion 11 into a compressed digital signal; an intermediate-frequency processing circuit portion 15 that converts the IF signal outputted from the tuner circuit portion 11 into an audio intermediate-frequency signal (hereinafter referred to as “SIF signal”); a digital circuit portion 13 that converts the compressed digital signal outputted from the digital demodulating portion 12 into digital video and audio signals; a video/audio output circuit 14 that converts the digital video and audio signals outputted from the digital circuit portion 13 into analog video and audio signals; and a power supply portion 16 that feeds the tuner circuit portion 11, the digital demodulating portion 12, the digital circuit portion 13, the video/audio output circuit 14, and the intermediate-frequency processing circuit portion 15 with electric power from which they operate.

The digital demodulating portion 12 is provided with a digital demodulating IC 21, which is a processing IC for converting the IF signal into a digital signal. The intermediate-frequency processing circuit portion 15 is provided with an intermediate-frequency processing IC 25, which is a processing IC for converting the IF signal into the SIF signal. The digital circuit portion 13 is provided with: a video/audio processing IC 24 for extracting video and audio signals from the compressed digital signal; a video/audio processing memory 22 for storing compressed digital video and audio signals and demodulated digital video and audio signals; and a program memory 23 for storing control codes for controlling the receiver apparatus. A serial control signal for controlling the tuner circuit portion 11 and the digital demodulating IC 21 is fed to the video/audio processing IC 24.

The video display apparatus 4 is provided with: a display processing portion 31 that performs processing for displaying video based on the analog video signal fed from the receiver apparatus 3; an audio processing portion 32 that performs processing for outputting audio based on the analog audio signal fed from the receiver apparatus 3; and a power supply portion 33 that feeds the display processing portion 31 and the audio processing portion 32 with electric power from which they operate. The audio processing portion 32 is provided with a demodulating circuit for demodulating the SIF signal fed from the intermediate-frequency processing circuit portion 15.

With the configuration described above, the receiver system 1, for example, receives digital and analog broadcast signals, converts them into video and/or audio signals, and outputs these signals (displays video and outputs audio).

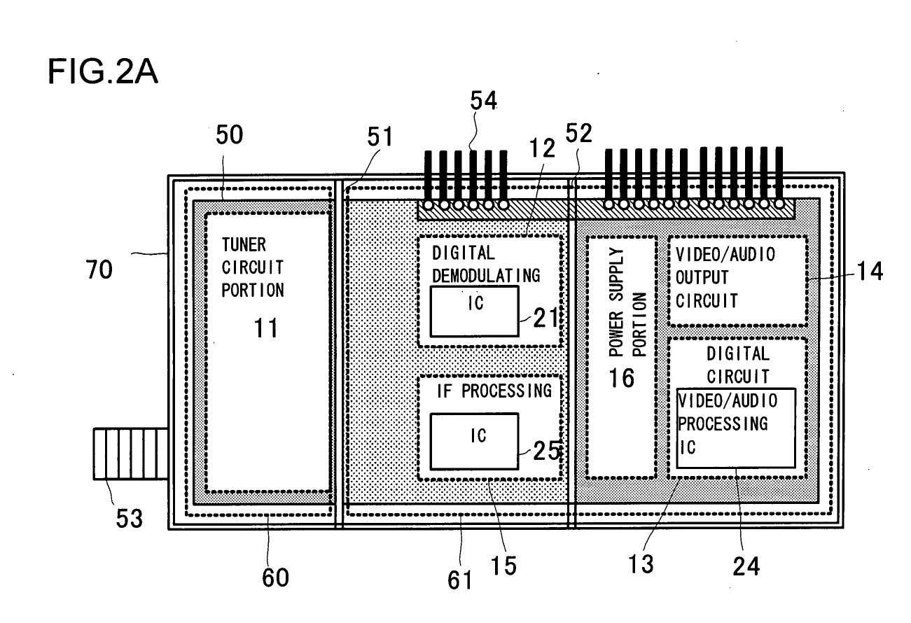

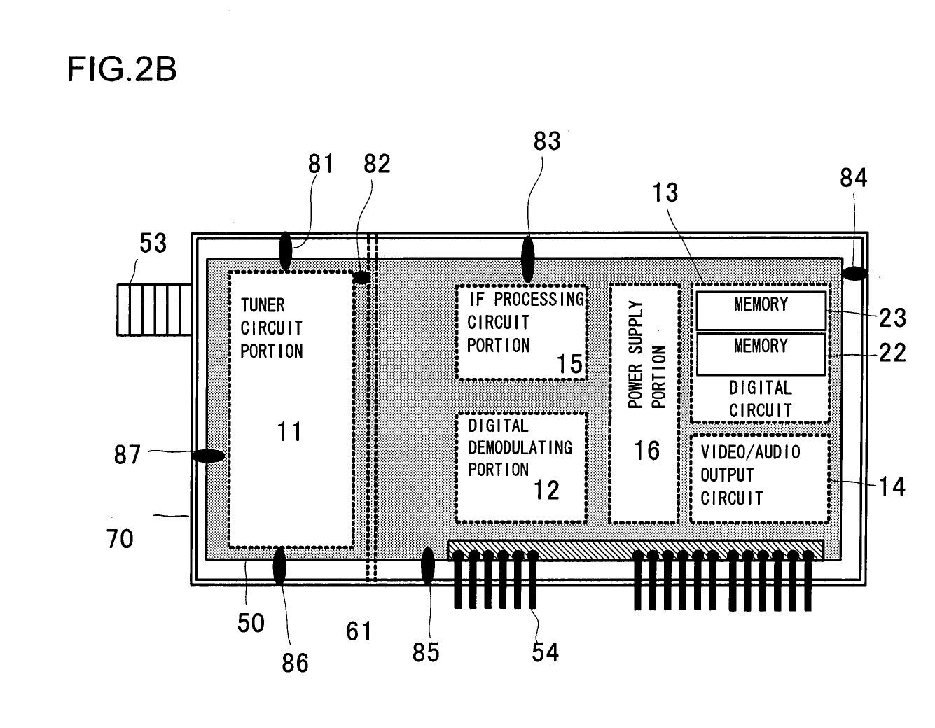

FIG. 2 is a diagram schematically showing how different functional sections are mounted on the receiver apparatus 3 shown in FIG. 1, FIG. 2A showing the receiver apparatus 3 as seen from one side (top face) thereof, FIG. 2B showing the receiver apparatus 3 as seen from the other side (bottom face) thereof.

As shown in FIG. 2A, the receiver apparatus 3 is built on a circuit board 50, and a first shield plate 51 is placed on the circuit board 50 so as to divide it into two parts that are thereby electromagnetically shielded from each other.

The tuner circuit portion 11 is mounted on a first part 60 of the circuit board 50, which is one of the two divided parts of the circuit board 50 that are shielded from each other by the first shield plate 51. The circuit board 50 is fitted to a chassis 70, and the analog ground pattern of the tuner circuit portion 11 is electrically connected to the chassis 70. The circuit board 50 is provided with a tuner input terminal 53, via which the radio-frequency signal received by the antenna 2 is fed to the tuner circuit portion 11. The chassis 70 has lids fitted thereto, one on the top face and another on the bottom face thereof, and thus the first part 60 and a second part 61, which is the other of the two parts of the circuit board 50 shielded from each other by the first shield plate 51, are covered with a shield.

The top and bottom faces of the circuit board 50 may be entirely covered with the chassis 70; or furthermore the circuit board 50 may be enclosed in the chassis 70; or the circuit board 50 may be substantially hermetically enclosed in the chassis 70. In any of these ways, it is possible to minimize the entry of noise from outside into the components on the circuit board 50.

On the second part 61 are mounted the digital demodulating portion 12, the digital circuit portion 13, the video/audio output circuit 14, the intermediate-frequency processing circuit portion 15, and the power supply portion 16. As described above, the second part 61 is electromagnetically shielded by the first shield plate 51.

The second part 61 is further provided with a connector 54 at one edge thereof. The connector 54 includes, in addition to the input/output terminals of the tuner circuit portion 11, the input/output terminals related to the functional sections mounted on the second part 61, namely the digital demodulating portion 12, the digital circuit portion 13, the video/audio output circuit 14, the intermediate-frequency processing circuit portion 15, and the power supply portion 16. Within the connector 54, near the first part 60 is arranged the IF output terminal of the tuner circuit portion 11, and via this IF output terminal, the IF signal is outputted. Within the connector 54, away from the first part 60 are arranged the output terminal and the ground terminal of the video/audio output circuit 14.

The connector 54 is arranged in a concentrated fashion at one edge of the second part 61; specifically, the connector 54 is arranged at the edge of the second part 61 located in the direction forming the letter “L” with respect to the axis of the tuner input terminal 53.

The digital demodulating portion 12 and the digital circuit portion 13 are electromagnetically shielded from each other with a second shield plate 52. As the circuit board 50, a multiple-layer circuit board is adopted, so that the digital demodulating IC 21 provided in the digital demodulating portion 12 and the video/audio processing IC 24 provided in the digital circuit portion 13 are electrically connected to each other via an interlayer conductor pattern laid inside the circuit board 50. These two ICs are mounted in positions apart from each other on the same face of the circuit board 50. Moreover, the packages of the digital demodulating IC 21 and the video/audio processing IC 24 each make contact with the chassis 70 via a thermally conductive member laid in between. Thus, the digital ground patterns of the digital demodulating portion 12 and the digital circuit portion 13 are each electrically connected to the chassis 70.

The connection of the digital ground patterns on the circuit board 50 to the chassis 70 and the connection of the above described analog ground pattern to the chassis 70 are all achieved with solder applied on the bottom face of the circuit board (see solder spots 81 to 87 shown in FIG. 2B). Here, the bottom face of the circuit board denotes the face thereof at which the distance therefrom to the lid is smaller, in other words, the face thereof at which the height with respect thereto of the side faces of the chassis is smaller. Performing soldering on the bottom face of the circuit board helps reduce the likeliness of the soldering machine or tool touching the side faces of the chassis during the manufacturing process of the receiver apparatus. This ensures highly efficient mounting.

Here, as shown in FIG. 2B, the spots at which the ground patterns are connected to the chassis are located not only at one edge of the circuit board 50 but at two or more edges thereof. This increases the number of connection points between the chassis and the ground patterns, and thus helps reduce the connection impedance. In the example shown in FIG. 2B, the soldering spots are located at all edges of the circuit board. This permits an increased number of connection points to be efficiently distributed over a wider area, contributing to an accordingly low impedance.

The digital circuit portion 13 has the video/audio processing IC 24 mounted on one face (top face) of the circuit board 50, and has the video/audio processing memory 22 and the program memory 23 mounted on the other face (bottom face) of the circuit board 50. The video/audio processing IC 24, the video/audio processing memory 22, and the program memory 23 are electrically connected together via the interlayer conductor pattern laid inside the circuit board 50.

The power supply terminals of the tuner circuit portion 11, the digital demodulating portion 12, the digital circuit portion 13, and the video/audio output circuit 14 are arranged, within the connector 54, between the output terminal of the video/audio output circuit 14 and the IF output terminal of the tuner circuit portion 11.

With this configuration, as the result of the digital circuit portion 13 and the video/audio output circuit 14 being mounted on the circuit board of the receiver apparatus 3, the video display apparatus 4 now needs to incorporate only the display processing portion 31′ for displaying video based on the video signal fed from the receiver apparatus 3 and the audio processing portion 32 for outputting audio based on the audio signal fed from the receiver apparatus 3. This eliminates the need to adopt a multiple-layer circuit board in the video display apparatus 4. In the conventional configuration, since the digital circuit portion is provided in the video display apparatus, measures against the unnecessary electromagnetic emission and noise generated by the video/audio processing IC, the video/audio processing memory, the program memory, and the like need to be taken in the video display apparatus. By contrast, with the configuration according to the present invention, the digital circuit portion is provided in the receiver apparatus, and thus the video display apparatus can be configured without a digital circuit portion. This eliminates the need to take measures against unnecessary electromagnetic emission and noise in the video display apparatus.

Moreover, the receiver apparatus 3 incorporates the intermediate-frequency processing circuit portion 15 for converting the IF signal into the SIF signal. This makes possible electrical connection with a video display apparatus provided with a demodulating circuit for the SIF signal.

The digital demodulating IC 21 and the video/audio processing IC 24 mounted on the circuit board of the receiver apparatus 3 are each connected to the chassis 70 via a thermally conductive member laid in between. Thus, measures against the heat generated by the IC packages are taken. On the other hand, in the video display apparatus, which no longer needs to be provided with IC packages, no measures need to be taken against heat as by increasing the area of the circuit board or providing it with an additional heat-dissipating plate.

With the configuration according to the present invention, within the receiver apparatus, the first part 60 composed of analog circuits and the second part 61 composed of digital circuits are shielded from each other. This prevents the digital noise generated by the digital demodulating portion and the digital circuit portion from entering the tuner circuit portion, and thus helps prevent degradation of the performance of the tuner circuit portion.

The analog ground pattern and the digital ground patterns are each electrically connected to the chassis 70. This eliminates the need to connect them, for ground connection, to the connector 54 provided on the second part 61, and also helps reduce the impedance between the analog and digital grounds.

The intermediate-frequency processing IC 25, the video/audio processing IC 24, and the digital demodulating IC 21 are arranged in positions apart from one another on the same mount face. This helps disperse the heat generated by the digital demodulating IC 21 provided in the digital demodulating portion 12 and the heat generated by the video/audio processing IC 24 provided in the digital circuit portion 13, and thereby helps prevent degradation of performance more effectively.

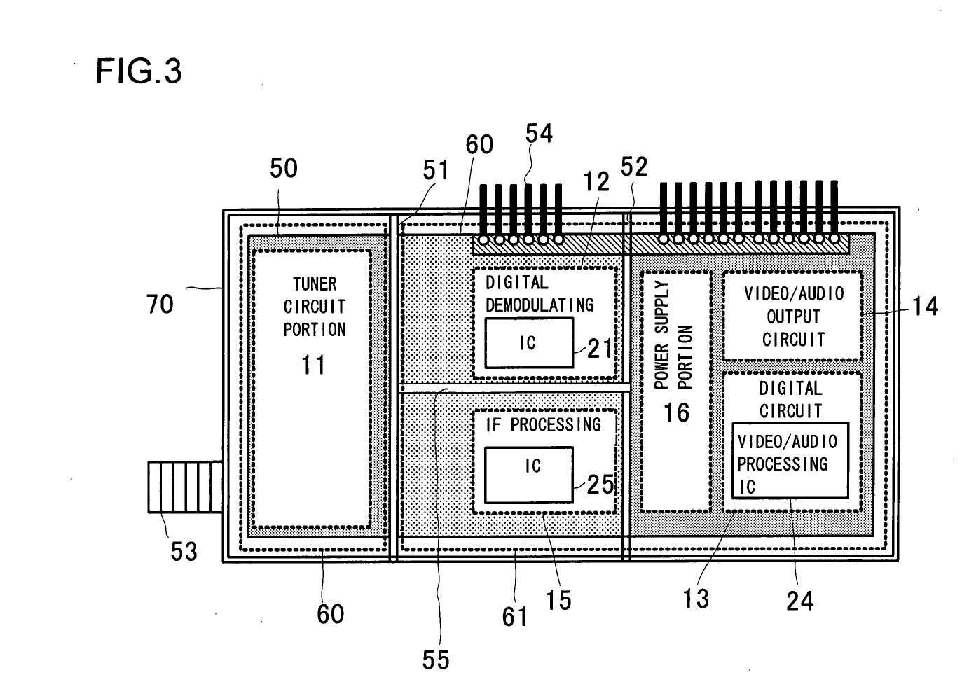

FIG. 3 shows a modified embodiment of what is shown in FIG. 2A. Here, as shown in FIG. 3, the digital demodulating portion 12 and the intermediate-frequency processing circuit portion 15 are shielded from each other with a third shield plate 55. This prevents the digital noise generated by the digital demodulating portion 12 from entering the intermediate-frequency processing IC 25, and thus helps prevent degradation of performance.

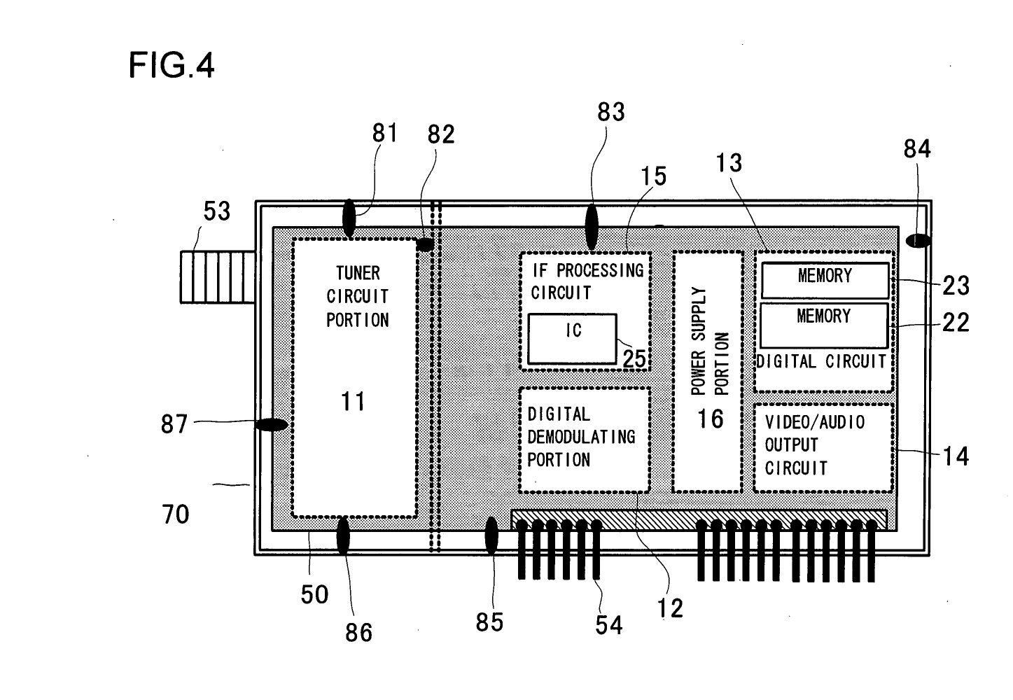

FIG. 4 shows a modified embodiment of what is shown in FIG. 2B. Here, as shown in FIG. 4, the intermediate-frequency processing IC 25 is arranged on the face of the circuit board different from the face thereof on which the video/audio processing IC 24 and the digital demodulating IC 21 are arranged (in FIG. 4, the intermediate-frequency processing IC 25 is arranged on the bottom face of the circuit board, and the video/audio processing IC 24 and the digital demodulating IC 21 are arranged on the top face of the circuit board). This configuration prevents the digital noise generated by the digital demodulating portion 12 or the digital circuit portion 13 from entering the intermediate-frequency processing circuit portion 15, and thus helps prevent degradation of performance.

The first part 60 and the second part 61 are shielded from each other with the first shield plate 51. This prevents the unnecessary electromagnetic emission generated by the digital demodulating portion 12 and the digital circuit portion 13 mounted on the second part 61 from entering the tuner circuit portion 11 mounted on the first part 60.

Furthermore, on the second part 61, the digital demodulating portion 12 and the digital circuit portion 13 are shielded from each other with a second shield plate 52. This prevents the unnecessary electromagnetic emission generated by the digital circuit portion 13 from entering the digital demodulating portion 12.

According to the configuration described above as an embodiment of the present invention, a digital circuit portion and a video/audio output circuit, which are conventionally incorporated in a video display apparatus, are mounted on the circuit board of a receiver apparatus. This makes it possible to realize a video display apparatus with a single-layer circuit board instead of a multiple-layer circuit board. Furthermore, a video processing IC no longer needs to be mounted on the circuit board of the video display apparatus, and thus no measures need to be taken against the heat dissipated from this IC. It is thus possible to realize a receiver system with a video display apparatus having a simple configuration. Moreover, an intermediate-frequency processing circuit portion for converting an intermediate-frequency signal into an audio intermediate-frequency signal is now provided in the receiver apparatus. This makes possible electrical connection with a video display apparatus that is provided with a demodulating circuit for an audio intermediate-frequency signal.

What is claimed is:

1. A receiver apparatus that converts a radio-frequency signal received by an antenna into video and audio signals, comprising:
a tuner circuit portion that converts the radio-frequency signal received by the antenna into an intermediate-frequency signal;
a digital demodulating portion that converts the intermediate-frequency signal outputted from the tuner circuit portion into a compressed digital signal;
an intermediate-frequency processing circuit portion that converts the intermediate-frequency signal outputted from the tuner circuit portion into an audio intermediate-frequency signal;
a digital circuit portion that converts the compressed digital signal outputted from the digital demodulating portion into digital video and audio signals; and
a video/audio output circuit that converts the digital video and audio signals outputted from the digital circuit portion into analog video and audio signals,
wherein
the tuner circuit portion, the digital demodulating portion, the intermediate-frequency processing circuit portion, the digital circuit portion, and the video/audio output circuit are arranged on a single circuit board, and
top and bottom faces of the single circuit board are entirely covered with a chassis.

2. The receiver apparatus of claim 1, wherein
the single circuit board is enclosed in the chassis.

3. The receiver apparatus of claim 1, wherein
the intermediate-frequency processing circuit portion comprises an intermediate-frequency processing IC for converting the intermediate-frequency signal into the audio intermediate-frequency signal,
the digital circuit portion comprises:
a video/audio processing IC that demodulates compressed digital video and audio signals; and
a video/audio processing memory that stores the compressed digital video and audio signals and demodulated digital video and audio signals,
the digital demodulating portion comprises a digital demodulating IC, which is a processing IC for converting the intermediate-frequency signal into a digital signal, and
the intermediate-frequency processing IC, the video/audio processing IC, and the digital demodulating IC are arranged in positions apart from one another on a same mount face.

4. The receiver apparatus of claim 1, wherein
the intermediate-frequency processing circuit portion comprises an intermediate-frequency processing IC for converting the intermediate-frequency signal into the audio intermediate-frequency signal,
the digital circuit portion comprises:
a video/audio processing IC that demodulates the compressed digital video and audio signals; and
a video/audio processing memory that stores the compressed digital video and audio signals and demodulated digital video and audio signals,
the digital demodulating portion comprises a digital demodulating IC, which is a processing IC for converting the intermediate-frequency signal into a digital signal,
the intermediate-frequency processing IC, the video/audio processing IC, and the digital demodulating IC are arranged in positions apart from one another on a same mount face, and
the intermediate-frequency processing circuit portion is electromagnetically shielded from the video/audio processing IC and the digital demodulating IC.

5. The receiver apparatus of claim 1, wherein
the intermediate-frequency processing circuit portion comprises an intermediate-frequency processing IC for converting the intermediate-frequency signal into the audio intermediate-frequency signal,
the digital circuit portion comprises:
a video/audio processing IC that demodulates compressed digital video and audio signals; and
a video/audio processing memory that stores the compressed digital video and audio signals and demodulated digital video and audio signals,
the digital demodulating portion comprises a digital demodulating IC, which is a processing IC for converting the intermediate-frequency signal into a digital signal,
the video/audio processing IC and the digital demodulating IC are arranged in positions apart from each other on a same mount face, and
the intermediate-frequency processing IC is arranged on a face opposite from the mount face where the video/audio processing IC and the digital demodulating IC are arranged.

6. A receiver system that receives digital and analog broadcast signals, converts them into video and audio signals, and displays video and/or outputs audio according thereto, the receiver system comprising:
the receiver apparatus of claim 1; and
a video display apparatus that displays video based on a video signal outputted from the receiver apparatus and/or outputs audio based on an audio signal outputted from the receiver apparatus.
